(19) United States
(12) Patent Application Publication
(10) Pub. No.: US 2011/0264538 A1
(43) Pub. Date: Oct. 27, 2011

(54) AUCTION METHOD AND SYSTEM USING BIDS DEPENDING ON CLICKS OR VIEWS AND FIXED UNIT PRICE DEPENDING ON PERIOD, ADVERTISING METHOD AND SYSTEM, AND CHARGING METHOD AND SYSTEM

(75) Inventors: Choong Hee Lee, Seongnam-si (KR); Joongoo Lee, Seongnam-si (KR); Young Nahn Baek, Seongnam-si (KR); Ju Young Yang, Seongnam-si (KR); Choong Hyun Nam, Seongnam-si (KR); Jae Hyun Han, Seongnam-si (KR)

(73) Assignee: NHN BUSINESS PLATFORM CORP., Seongnam-si (KR)

(21) Appl. No.: 13/126,662

(22) PCT Filed: Mar. 24, 2009
(86) PCT No.: PCT/KR2009/001455

§ 371 Date: Jul. 18, 2011

(30) Foreign Application Priority Data
Nov. 4, 2008 (KR) 10-2008-0108836

(51) Int. Cl. G06Q 30/00

(52) U.S. Cl. 705/14.71

(57) ABSTRACT

Disclosed are an auction method and system, an advertising method and system, and a charging method and system, based on a bid price depending on clicks or exposures, and a fixed unit price depending on a time period. The advertising method may include verifying an advertisement exposure priority determined with respect to an advertisement of an advertiser, based on a bid price per click (or a bid price per exposure) which may be input from the advertiser, and exposing the advertisement of the advertiser through an advertisement exposure region depending on the verified advertisement exposure priority, during a time period corresponding to a period-based flat rate unit price determined through an administrator system, wherein an advertising fee depending on the exposure of the advertisement may be calculated based on the bid price per click (or the bid price per exposure), a number of clicks (or a number of exposures) which may actually occur with respect to the advertisement during the time period, and the period-based flat rate unit price.

### TECHNICAL FIELD

Exemplary embodiments of the present invention relate to an auction method and system, an advertising method and system, and a charging method and system, based on a bid price depending on clicks or exposures, and a fixed unit price depending on a time period, and more particularly, to a method and system that may perform an auction and advertising based on a bid price depending on clicks (or exposures), and may calculate an advertising fee based on both the bid price, and a period-based flat rate unit price set to be equal with respect to a predetermined time period.

### BACKGROUND ART

Internet advertising, that is, advertising through the medium of the Internet, enables enterprises to contact a great number of consumers at a low cost and immediately recognize reactions of customers through an advertisement using merits of the Internet. Among the Internet advertising methods, keyword advertising refers to an advertising method that exposes an advertisement of a relevant enterprise on a screen as a search result upon input of a search term. For example, when a user inputs a search term related to ‘moving’, advertisements related to ‘pack moving’, ‘moving center’, and the like may be exposed as a result of the search. Thus, since advertisements are exposed to those interested in particular goods or services, the advertising effect will be high. A method and system which may more efficiently and effectively perform an auction, advertising, and charging with respect to the Internet advertising will be described herein.

### DISCLOSURE OF INVENTION

### Technical Goals

Exemplary embodiments of the present invention provide an auction method and system that may determine an advertisement exposure priority based on a bid price per click (or a bid price per exposure), which may be input by advertisers so as to be guaranteed a position where an advertisement may be exposed during a predetermined time period.

Exemplary embodiments of the present invention also provide an advertising method and system that may expose an advertisement of a corresponding advertiser through an advertisement exposure region corresponding to the advertisement exposure priority determined based on the bid price per click, among a plurality of advertisement exposure regions included in a webpage.

Exemplary embodiments of the present invention also provide a charging method and system that may calculate an advertising fee based on the bid price per click (or the bid price per exposure), a period-based flat rate unit price determined through an administrator system, and a number of clicks (or a number of exposures) which may actually occur during a time period corresponding to the period-based flat rate unit price.

### Technical Solutions

An exemplary embodiment of the present invention discloses an advertising method including verifying an advertisement exposure priority determined with respect to an advertisement of an advertiser, based on a bid price per click (or a bid price per exposure) which may be input from the advertiser, and exposing the advertisement of the advertiser through an advertisement exposure region depending on the verified advertisement exposure priority, during a time period corresponding to a period-based flat rate unit price determined through an administrator system, wherein an advertising fee depending on the exposure of the advertisement may be calculated based on the bid price per click (or the bid price per exposure), a number of clicks (or a number of exposures) which may actually occur with respect to the advertisement during the time period, and the period-based flat rate unit price.

The advertisement exposure priority may correspond to information regarding which advertisement exposure region an advertisement may be exposed through, among a plurality of advertisement exposure regions included on a single webpage, and when the bid price per click (or the bid price per exposure) is input to be higher, the advertisement may be determined to be exposed through an uppermost position of the advertisement exposure region of the webpage.

The advertising fee may be calculated based on a specific fee per click (or a specific fee per exposure) determined based on the bid price per click (or the bid price per exposure) and based on the number of clicks (or the number of exposures), a period-based flat rate fee determined based on the period-based flat rate unit price, and a weight for each fee determined by the advertiser. In this instance, the weight for each fee may include at least one of a ratio used to reflect the specific fee per click (or the specific fee per exposure) in the advertising fee, and a ratio used to reflect the period-based flat rate fee in the advertising fee.

An exemplary embodiment of the present invention also discloses an advertising system, including an advertisement exposure priority verification unit to verify an advertisement exposure priority determined with respect to an advertisement of an advertiser, based on a bid price per click (or a bid price per exposure) which may be input from the advertiser, and an advertisement exposure unit to expose the advertisement of the advertiser through an advertisement exposure region depending on the verified advertisement exposure priority, during a time period corresponding to a period-based flat rate unit price determined through an administrator system, wherein an advertising fee depending on the exposure of the advertisement may be calculated based on the bid price per click (or the bid price per exposure), a number of clicks (or a number of exposures) which may actually occur with respect to the advertisement during the time period, and the period-based flat rate unit price.

An exemplary embodiment of the present invention also discloses an auction method, including verifying a bid price per click (or a bid price per exposure) which may be input from at least one advertiser, and determining an advertisement exposure priority with respect to an advertisement of the advertiser based on the bid price per click (or the bid price per exposure), wherein the advertisement may be exposed through an advertisement exposure region depending on the advertisement exposure priority, and an advertising fee depending on the exposure of the advertisement may be calculated based on the bid price per click (or the bid price per exposure), a period-based flat rate unit price determined through an administrator system, and a number of clicks (or a number of exposures) which may actually occur with respect to the advertisement during a time period corresponding to the period-based flat rate unit price.

An exemplary embodiment of the present invention also discloses an auction system, including a bid price per click (or bid price per exposure) verification unit to verify a bid price per click (or a bid price per exposure) which may be input from at least one advertiser, and an advertisement exposure priority determination unit to determine an advertisement exposure priority with respect to an advertisement of the advertiser based on the bid price per click (or the bid price per exposure), wherein the advertisement may be exposed through an advertisement exposure region depending on the advertisement exposure priority, and an advertising fee depending on the exposure of the advertisement may be calculated based on the bid price per click (or the bid price per exposure), a period-based flat rate unit price determined through an administrator system, and a number of clicks (or a number of exposures) which may actually occur with respect to the advertisement during a time period corresponding to the period-based flat rate unit price.

An exemplary embodiment of the present invention also discloses a charging method, including verifying a bid price per click (or a bid price per exposure) of an advertisement exposed through an advertisement exposure region, verifying a period-based flat rate unit price determined through an administrator system, verifying a number of clicks (or a number of exposures) which may actually occur with respect to the advertisement during a time period corresponding to the period-based flat rate unit price, and calculating an advertising fee depending on the exposure of the advertisement, based on the bid price per click (or the bid price per exposure), the number of clicks (or the number of exposures), and the period-based flat rate unit price.

An exemplary embodiment of the present invention also discloses a charging system, including a bid price per click (or bid price per exposure) verification unit to verify a bid price per click (or a bid price per exposure) of an advertisement exposed through an advertisement exposure region, a period-based flat rate unit price verification unit to verify a period-based flat rate unit price determined through an administrator system, a number of clicks (or number of exposures) verification unit to verify a number of clicks (or a number of exposures) which may actually occur with respect to the advertisement during a time period corresponding to the period-based flat rate unit price, and an advertising fee calculation unit to calculate an advertising fee depending on the exposure of the advertisement, based on the bid price per click (or the bid price per exposure), the number of clicks (or the number of exposures), and the period-based flat rate unit price.

### ADVANTAGEOUS EFFECTS

According to embodiments of the present invention, uncertainty of an advertising fee which may occur according to flexibility of a number of clicks (or a number of exposures) may be reduced by determining an advertisement exposure priority through an auction using a bid price per click (or a bid price per exposure), and by calculating an advertising fee depending on an exposure of an advertisement through an advertisement exposure region corresponding to the advertisement exposure priority, based on both the bid price per click (or the bid price per exposure), and a period-based flat rate unit price determined through an administrator system.

According to embodiments of the present invention, various charging policies which may satisfy a request of an advertiser may be implemented by adjusting a ratio between a period-based flat rate fee determined based on the period-based flat rate unit price, and a specific fee per click (or a specific fee per exposure) determined based on the bid price per click (or the bid price per exposure) and based on the number of clicks (or the number of exposures).

### BRIEF DESCRIPTION OF DRAWINGS

FIG. 1 is a diagram illustrating a general configuration of an auction system, an advertising system, and a charging system according to an embodiment of the present invention.

FIG. 2 is a flowchart illustrating an auction method according to an embodiment of the present invention.

FIG. 3 is a diagram illustrating a configuration of an auction system according to an embodiment of the present invention.

FIG. 4 is a flowchart illustrating an advertising method according to an embodiment of the present invention.

FIG. 5 is a diagram illustrating a configuration of an advertising system according to an embodiment of the present invention.

FIG. 6 is a flowchart illustrating a charging method according to an embodiment of the present invention.

FIG. 7 is a diagram illustrating a configuration of a charging system according to an embodiment of the present invention.

FIG. 8 is an example of a table including information regarding a relationship among a bid price per click, a period-based flat rate unit price, a number of clicks, and an advertising fee.

### BEST MODE FOR CARRYING OUT THE INVENTION

The invention is described more fully hereinafter with reference to the accompanying drawings, in which embodiments of the invention are shown.

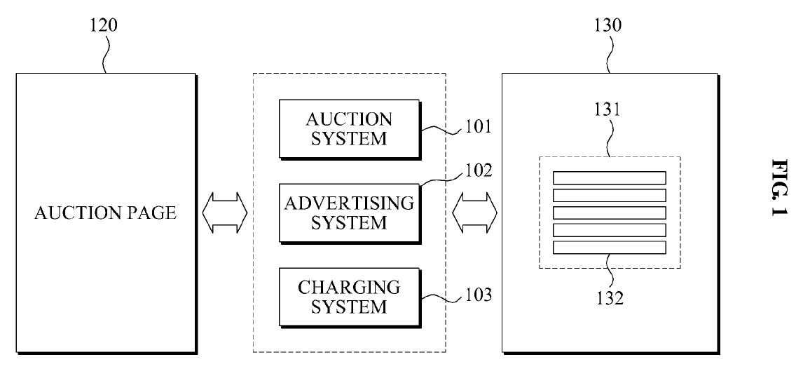

FIG. 1 is a diagram illustrating a general configuration of an auction system 101, an advertising system 102, and a charging system 103 according to an embodiment of the present invention. Each of the auction system 101, the advertising system 102, and the charging system 103 may exist in a form of a separate system, or in a form of a system where at least two systems of the three systems may be combined. For example, all of the auction system 101, the advertising system 102, and the charging system 103 may be included in a single system, or only the auction system 101 may be separated, and operated in conjunction with a system including the advertising system 102, and the charging system 103.

The auction system 101 may receive, from an advertiser, a bid price according to clicks, that is, a bid price per click, through an advertiser page, and an auction page 120 which may be used for conducting an auction with respect to an advertisement, and may also determine an advertisement exposure priority based on the bid price per click.

The advertising system 102 may expose a corresponding advertisement through an advertisement exposure region corresponding to the advertisement exposure priority, determined through the auction system 101. For example, the advertising system 102 may expose the corresponding advertisement through a fifth advertisement exposure region 132 corresponding to a fifth advertisement exposure priority, among a plurality of advertisement exposure regions included in an advertising region 131 of a predetermined webpage 130. In this instance, the advertising system 102 may expose the advertisement by setting a link to a document corresponding to the advertisement on the fifth advertisement exposure region 132 and by providing a user with the document according to an event occurring with respect to the link by the user who may browse the webpage 130.

The charging system 103 may calculate an advertising fee depending on the exposure of the advertisement. In this instance, the charging system 103 may calculate the advertising fee based on the bid price per click and a period-based flat rate unit price, thereby reducing uncertainty which may occur according to flexibility of the number of clicks.

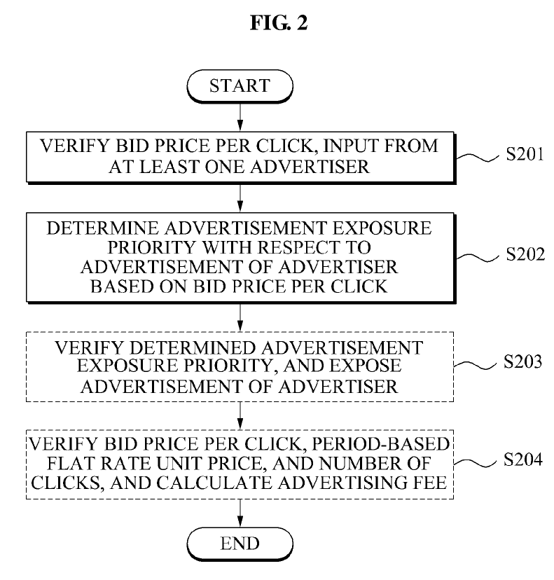

FIG. 2 is a flowchart illustrating an auction method according to an embodiment of the present invention. The auction method may be performed through the auction system 101, which has been described with reference to FIG. 1. In FIG. 2, the auction method will be described by describing a process of performing each operation by the auction system 101.

In operation S201, the auction system 101 may verify a bid price per click which may be input from at least one advertiser. Here, the bid price per click may correspond to a bid price which may be input by the advertiser so as to be guaranteed a position where an advertisement may be exposed during a predetermined time period, in an auction with respect to the position where the advertisement may be exposed. Whether the advertiser may successfully bid for the position may be determined based on the bid price per click.

In operation S202, the auction system 101 may determine an advertisement exposure priority with respect to the advertisement of the advertiser based on the bid price per click. The advertisement exposure priority may correspond to information regarding which advertisement exposure region an advertisement may be exposed through, among a plurality of advertisement exposure regions included on a single webpage. When the bid price per click is input to be higher, the auction system 101 may determine the advertisement exposure priority to enable exposure of the advertisement, through an uppermost position of the advertisement exposure region of the webpage. For example, the auction system 101 may determine to apply the highest advertisement exposure priority to an advertisement of an advertiser who may suggest the highest bid price per click, among all verified bid prices per click, and then the advertisement having the highest advertisement exposure priority may be exposed through the uppermost position of the advertisement exposure region of the webpage. At least one form of auctions among all possible forms of auctions may be used for the successful bid for the bid price per click.

In this instance, the advertisement may be exposed, through the advertisement exposure region corresponding to the advertisement exposure priority, during a time period corresponding to a period-based flat rate unit price determined through an administrator system, and an advertising fee depending on the exposure of the advertisement may be calculated based on the bid price per click, the period-based flat rate unit price, and a number of clicks which may actually occur with respect to the advertisement during the time period corresponding to the period-based flat rate unit price. That is, uncertainty of the advertising fee which may occur according to flexibility of the number of clicks may be reduced by determining the advertisement exposure priority through an auction using the bid price per click, by exposing the advertisement through the advertisement exposure region corresponding to the advertisement exposure priority, and by calculating the advertising fee depending on the exposure of the advertisement based on the bid price per click, the period-based flat rate unit price determined through the administrator system, and the number of clicks which may actually occur with respect to the advertisement during a time period corresponding to the period-based flat rate unit price. Here, the administrator system may refer to a system including at least one of the auction system 101, the advertising system 102, and the charging system 103, or a system including at least two systems of the three systems.

Also, the advertising fee may be calculated based on a specific fee per click determined based on the bid price per click and the number of clicks, a period-based flat rate fee determined based on the period-based flat rate unit price, and a weight for each fee determined through the administrator system in accordance with a request of the advertiser. Here, the weight for each fee may include at least one of a ratio used to reflect the specific fee per click in the advertising fee, and a ratio used to reflect the period-based flat rate fee in the advertising fee. That is, various charging policies which may satisfy a request of an advertiser may be implemented by calculating the advertising fee based on a ratio between the period-based flat rate fee and the specific fee per click. For example, calculation of an advertising fee satisfying requests of both advertisers who may desire to increase a portion of a fee predetermined with respect to a predetermined time period, and advertisers who may desire to increase a portion of the fee depending on a number of clicks may be possible by an administrator system determining, a weight for each fee with respect to the period-based flat rate fee, and a weight for each fee with respect to the specific fee per click according to the requests of the advertisers, and by adjusting portions of the fees corresponding to the period-based flat rate fee and the specific fee per click in the entire advertising fee.

In this instance, the exposure of the advertisement and the calculation of the advertising fee may be performed by the advertising system 102 and the charging system 103 which have been described with reference to FIG. 1. That is, operations S203 and S204 displayed in dotted line boxes in FIG. 2 may be operations which may be performed after the advertisement exposure priority is determined, and may be to performed by the advertising system 102 and the charging system 103 respectively.

In operation S203, the advertising system 102 may verify an advertisement exposure priority determined with respect to an advertisement of an advertiser, based on a bid price per click which may be input from the advertiser, and may expose the advertisement of the advertiser through an advertisement exposure region depending on the verified advertisement exposure priority, during a time period corresponding to a period-based flat rate unit price determined through an administrator system.

In operation S204, the charging system 103 may verify a bid price per click of an advertisement exposed through an advertisement exposure region, a period-based flat rate unit price determined through an administrator system, and a number of clicks which may actually occur with respect to the advertisement during a time period corresponding to the period-based flat rate unit price, and may calculate an advertising fee depending on the exposure of the advertisement based on the bid price per click, the number of clicks, and the period-based flat rate unit price.

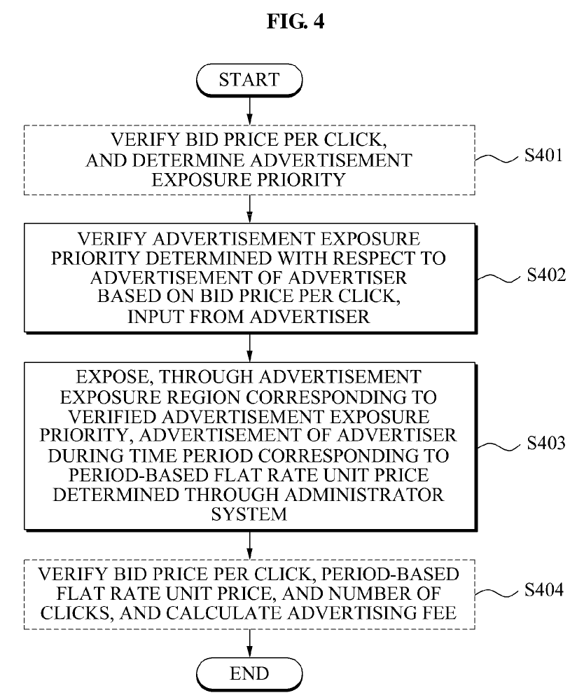

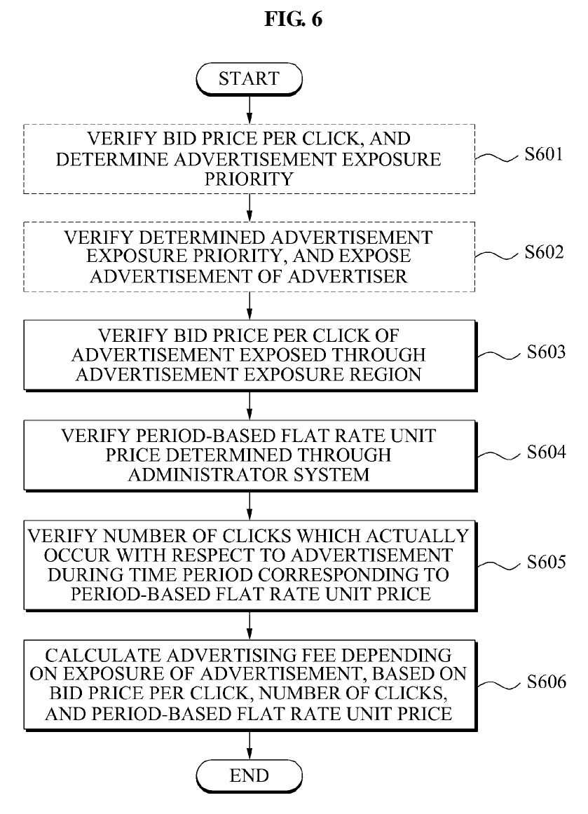

An advertising method and a charging method similar to operations S203 and S204 will be further described with reference to FIGS. 4 and 6.

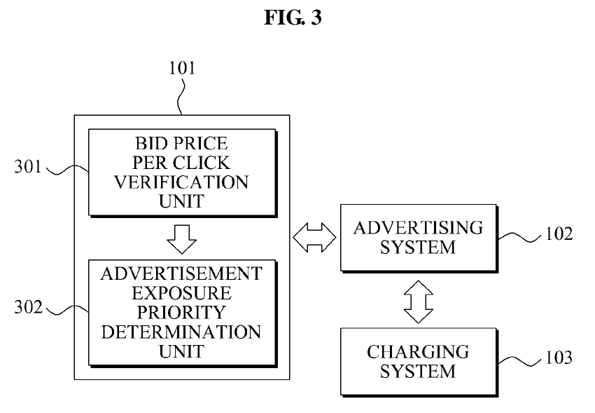

FIG. 3 is a diagram illustrating a configuration of the auction system 101 according to an embodiment of the present invention. The auction system 101 may include a bid price per click verification unit 301 and an advertisement exposure priority determination unit 302, as illustrated in FIG. 3.

The bid price per click verification unit 301 may verify a bid price per click which may be input from at least one advertiser. Here, the bid price per click may correspond to a bid price which may be input by the advertiser so as to be guaranteed a position where an advertisement may be exposed during a predetermined time period, in an auction with respect to the position where the advertisement may be exposed. Whether the advertiser may successfully bid for the position may be determined based on the bid price per click.

The advertisement exposure priority determination unit 302 may determine an advertisement exposure priority with respect to an advertisement of the advertiser based on the bid price per click. In this instance, the advertisement exposure priority may correspond to information regarding which advertisement exposure region an advertisement may be exposed through, among a plurality of advertisement exposure to regions included on a single webpage, and the advertisement exposure priority determination unit 302 may determine the advertisement exposure priority to enable exposure, through an uppermost position of the advertisement exposure region of the webpage, of an advertisement of an advertiser who may suggest a higher bid price per click. For example, the advertisement exposure priority determination unit 302 may determine to apply the highest advertisement exposure priority to an advertisement of an advertiser who may suggest the highest bid price per click, among all verified bid prices per click, and then the advertisement having the highest advertisement exposure priority may be exposed through the uppermost position of the advertisement exposure region of the webpage. At least one form of auctions among all possible forms of auctions may be used for the successful bid for the bid price per click.

In this instance, the advertisement may be exposed, through the advertisement exposure region corresponding to the advertisement exposure priority, during a time period corresponding to a period-based flat rate unit price determined through an administrator system, and an advertising fee depending on the exposure of the advertisement may be calculated based on the bid price per click, the period-based flat rate unit price, and a number of clicks which may actually occur with respect to the advertisement during the time period corresponding to the period-based flat rate unit price. That is, uncertainty of the advertising fee which may occur according to flexibility of the number of clicks may be reduced by determining the advertisement exposure priority through an auction using the bid price per click, by exposing the advertisement through the advertisement exposure region corresponding to the advertisement exposure priority, and by calculating the advertising fee depending on the exposure of the advertisement based on the bid price per click, the period-based flat rate unit price determined through the administrator system, and the number of clicks which may actually occur with respect to the advertisement during the time period corresponding to the period-based flat rate unit price. Here, the administrator system may refer to a system including at least one of the auction system 101, the advertising system 102, and the charging system 103, or a system including at least two systems of the three systems.

Also, the advertising fee may be calculated based on a specific fee per click determined based on the bid price per click and the number of clicks, a period-based flat rate fee determined based on the period-based flat rate unit price, and a weight for each fee determined through an administrator system in accordance with a request of the advertiser. Here, the weight for each fee may include at least one of a ratio used to reflect the specific fee per click in the advertising fee, and a ratio used to reflect the period-based flat rate fee in the advertising fee. That is, various charging policies which may satisfy a request of an advertiser may be implemented by calculating the advertising fee based on a ratio between the period-based flat rate fee and the specific fee per click. For example, a calculation of an advertising fee satisfying requests of both advertisers who may desire to increase a portion of a fee predetermined with respect to a predetermined time period, and advertisers who may desire to increase a portion of the fee depending on a number of clicks may be possible, by applying, to each fee, a weight for each fee with respect to the period-based flat rate fee, and a weight for each fee with respect to the specific fee per click which may be input by each advertiser, and by adjusting portions of the fees corresponding to the period-based flat rate fee and the specific fee per click in the entire advertising fee.

FIG. 4 is a flowchart illustrating an advertising method according to an embodiment of the present invention. The advertising method may be performed through the advertising system 102, which has been described with reference to FIG. 1. In FIG. 4, the advertising method will be described by describing a process of performing each operation by the advertising system 102.

Operation S401 may correspond to an operation to roughly describe the auction method which has been described with reference to FIG. 2, and may be performed through the auction system 101 which has been described with reference to FIG. 1. In operation S401, the auction system 101 may verify a bid price per click which may be input from at least one advertiser, and may determine an advertisement exposure priority with respect to an advertisement of the advertiser based on the bid price per click. The determination process of the advertisement exposure priority has been described in detail with reference to FIG. 2, and accordingly a further description will be omitted.

In operation S402, the advertising system 102 may verify an advertisement exposure priority determined with respect to an advertisement of an advertiser, based on a bid price per click which may be input from the advertiser. As aforementioned, the advertisement exposure priority may correspond to information regarding which advertisement exposure region an advertisement may be exposed through, among a plurality of advertisement exposure regions included on a single webpage. When the bid price per click is input to be higher, the advertisement is determined to be exposed through an uppermost position of the advertisement exposure region of the webpage by the auction system 101 in operation S401, and then the advertising system 102 may verify the determined advertisement exposure priority.

In operation S403, the advertising system 102 may expose the advertisement of the advertiser through an advertisement exposure region depending on the verified advertisement exposure priority, during a time period corresponding to a period-based flat rate unit price determined through an administrator system. For example, the advertising system 102 may include information where a plurality of exposure regions from a first advertisement exposure region to a fifth advertisement exposure region may correspond to a plurality of priorities, such as from a first priority to a fifth priority respectively. When the advertisement exposure priority of a corresponding advertisement is the third priority, the advertisement may be exposed through the third advertisement exposure region corresponding to the third priority. The exposure of the advertisement may be performed by setting a link to a document corresponding to the advertisement in a corresponding advertisement exposure region of the webpage, and by providing a user with the document when an event occurs with respect to the link by the user who may browse the webpage.

Also, the advertising fee depending on the exposure of the advertisement may be calculated based on the bid price per click, a number of clicks which may actually occur with respect to the advertisement during the time period, and the period-based flat rate unit price. That is, uncertainty of the advertising fee which may occur according to flexibility of the number of clicks may be reduced by determining the advertisement exposure priority through an auction using the bid price per click, by exposing the advertisement through the advertisement exposure region corresponding to the advertisement exposure priority, and by calculating the advertising fee depending on the exposure of the advertisement based on the bid price per click, a period-based flat rate unit price determined through an administrator system, and the number of clicks which may actually occur with respect to the advertisement during a time period corresponding to the period-based flat rate unit price. For example, when a number of clicks during the time period is predicted with respect to the advertisement exposure region, however, the number of clicks which may actually occur is far different from the predicted number of clicks, the advertiser may need to pay an advertising fee much greater than expected. Accordingly, the advertising fee may be calculated based on the bid price per click, the number of clicks, and the period-based flat rate unit price, thereby reducing the uncertainty which may occur according to the flexibility of the number of clicks.

The advertising fee may be calculated based on a specific fee per click determined based on the bid price per click and the number of clicks, a period-based flat rate fee determined based on the period-based flat rate unit price, and a weight for each fee determined by the advertiser. The weight for each fee may include at least one of a ratio used to reflect the specific fee per click in the advertising fee, and a ratio used to reflect the period-based flat rate fee in the advertising fee. That is, various charging policies which may satisfy a request of an advertiser may be implemented by calculating the advertising fee based on a ratio between the period-based flat rate fee and the specific fee per click.

Operation S404 may correspond to an operation to roughly describe the charging method depending on the exposure of the advertisement, and may be performed through the charging system 103 which has been described with reference to FIG. 1. In operation S404, the charging system 103 may verify a bid price per click of an advertisement exposed through an advertisement exposure region, a period-based flat rate unit price determined through an administrator system, and a number of clicks which may actually occur with respect to the advertisement during a time period corresponding to the period-based flat rate unit price, and may calculate an advertising fee depending on the exposure of the advertisement, based on the bid price per click, and the number of clicks, and the period-based flat rate unit price. As aforementioned, the charging method will be further described with reference to FIG. 6.

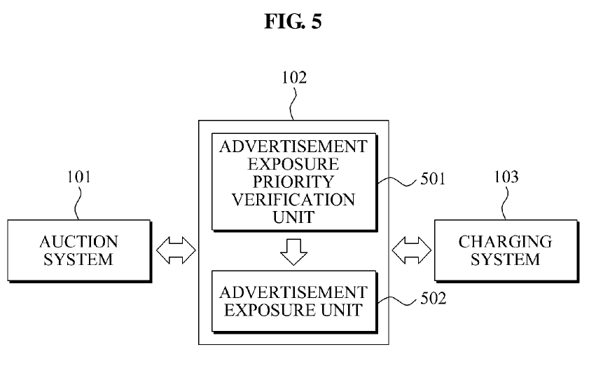

FIG. 5 is a diagram illustrating a configuration of the advertising system 102 according to an embodiment of the present invention. The advertising system 102 may include an advertisement exposure priority verification unit 501, and an advertisement exposure unit 502.

The advertisement exposure priority verification unit 501 may verify an advertisement exposure priority determined with respect to an advertisement of an advertiser, based on a bid price per click which may be input from the advertiser. As aforementioned, the advertisement exposure priority may correspond to information regarding which advertisement exposure region an advertisement may be exposed through, among a plurality of advertisement exposure regions included on a single webpage. When the bid price per click is input to be higher, the advertisement is determined to be exposed through an uppermost position of the advertisement exposure region of the webpage by the auction system 101, and then the advertisement exposure priority verification unit 501 may verify the determined advertisement exposure priority.

The advertisement exposure unit 502 may expose the advertisement of the advertiser through an advertisement exposure region depending on the verified advertisement exposure priority, during a time period corresponding to a period-based flat rate unit price determined through an administrator system. For example, the advertisement exposure unit 502 may include information where a plurality of exposure regions from a first advertisement exposure region to a fifth advertisement exposure region may correspond to a plurality of priorities, such as, from a first priority to a fifth priority respectively. When the advertisement exposure priority of a corresponding advertisement is the third priority, the advertisement may be exposed through the third advertisement exposure region corresponding to the third priority. The exposure of the advertisement may be performed by setting a link to a document corresponding to the advertisement in a corresponding advertisement exposure region of the webpage, and by providing a user with the document when an event occurs with respect to the link by the user who may browse the webpage.

Also, the advertising fee depending on the exposure of the advertisement may be calculated based on the bid price per click, and a number of clicks which may actually occur with respect to the advertisement during the time period, and the period-based flat rate unit price. The advertising fee may be calculated based on a specific fee per click determined based on the bid price per click and the number of clicks, a period-based flat rate fee determined based on the period-based flat rate unit price, and a weight for each fee determined by the advertiser. The weight for each fee may include at least one of a ratio used to reflect the specific fee per click in the advertising fee, and a ratio used to reflect the period-based flat rate fee in the advertising fee.

FIG. 6 is a flowchart illustrating a charging method according to an embodiment of the present invention. The charging method may be performed through the charging system 103, which has been described with reference to FIG. 1. In FIG. 6, the charging method will be described by describing a process of performing each operation by the charging system 103.

Operations S601 and S602 may be respectively performed by the auction system 101 and the advertising system 102 which have been described with reference to FIG. 1. In operation S601, the auction system 101 may verify a bid price per click which may be input from at least one advertiser, and may determine an advertisement exposure priority with respect to the advertisement of the advertiser based on the bid price per click. In operation S602, the advertising system 102 may verify an advertisement exposure priority determined with respect to an advertisement of an advertiser, based on a bid price per click which may be input from the advertiser, and may expose the advertisement of the advertiser through an advertisement exposure region depending on the verified advertisement exposure priority, during a time period corresponding to a period-based flat rate unit price determined through an administrator system. The method of determining the advertisement exposure priority and exposing the advertisement has been described in detail with reference to FIGS. 2 through 4, and accordingly a further description will be omitted.

In operation S603, the charging system 103 may verify a bid price per click of an advertisement exposed through an advertisement exposure region. That is, the charging system 103 may verify the bid price per click of the advertisement, among all bid prices per click which may be input from advertisers in operation S601. The advertisement may refer to an advertisement exposed through an advertisement exposure region corresponding to an advertisement exposure priority determined based on the bid price per click, among a plurality of advertisement exposure regions.

In operation S604, the charging system 103 may verify a period-based flat rate unit price determined through the administrator system. Here, the administrator system may refer to a system including at least one of the auction system 101, the advertising system 102, and the charging system 103, or a system including at least two systems of the three systems. The period-based flat rate unit price may be used to reduce uncertainty of the advertising fee which may occur according to flexibility of a number of clicks, by calculating the advertising fee based on both a specific fee per click depending on the bid price per click, and the period-based flat rate fee depending on a time period.

In operation S605, the charging system 103 may verify a number of clicks which may actually occur with respect to the advertisement during a time period corresponding to the period-based flat rate unit price. That is, the charging system 103 may calculate a specific fee per click depending on clicks which may occur, by verifying the bid price per click, and the number of clicks which may actually occur with respect to the advertisement. For example, the charging system 103 may calculate the specific fee per click by multiplying the bid price per click and the number of clicks.

In operation S606, the charging system 103 may calculate an advertising fee depending on the exposure of the advertisement, based on the bid price per click, the period-based flat rate unit price, and the number of clicks. The charging system 103 may calculate the advertising fee based on a specific fee per click determined based on the bid price per click and the number of clicks, a period-based flat rate fee determined based on the period-based flat rate unit price, and a weight for each fee determined through an administrator system in accordance with a request of the advertiser. That is, uncertainty that a number of clicks which may occur with respect to the advertisement during the time period may be unverifiable in advance may be reduced, and also an advertising fee depending on achievements of the advertisement may be calculated based on the bid price per click.

The weight for each fee may include at least one of a ratio used to reflect the specific fee per click in the advertising fee, and a ratio used to reflect the period-based flat rate fee in the advertising fee. When the weight for each fee determined by the administrator system in accordance with the request of the advertiser is used, portions of fees corresponding to the period-based flat rate fee where an advertising fee may be verified in advance before exposing the advertisement, and the specific fee per click where the advertising fee may be calculated based on benefits of the advertisement may be adjusted to satisfy the request of the advertiser.

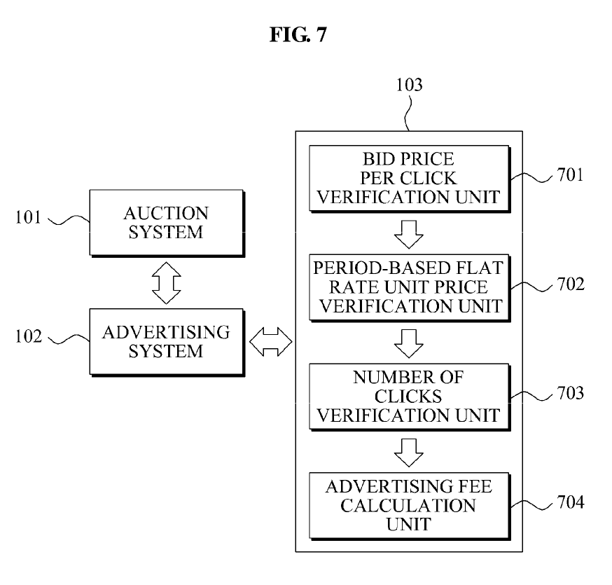

FIG. 7 is a diagram illustrating a configuration of the charging system 103 according to an embodiment of the present invention. The charging system 103 may include a bid price per click verification unit 701, a period-based flat rate unit price verification unit 702, a number of clicks verification unit 703, and an advertising fee calculation unit 704, as illustrated in FIG. 7.

The bid price per click verification unit 701 may verify a bid price per click of an advertisement exposed through an advertisement exposure region. The bid price per click verification unit 701 may verify the bid price per click of the advertisement, among all bid prices per click which may be input from the advertiser in the auction system 101. The advertisement may refer to an advertisement exposed through an advertisement exposure region corresponding to an advertisement exposure priority determined based on the bid price per click, among a plurality of advertisement exposure regions.

The period-based flat rate unit price verification unit 702 may verify a period-based flat rate unit price determined through an administrator system. The administrator system may refer to a system including at least one of the auction system 101, the advertising system 102, and the charging system 103, or a system including at least two systems of the three systems. The period-based flat rate unit price may correspond to a fixed advertising fee that may be paid during a corresponding time period, among the entire advertising fee, may reduce a portion of a fee corresponding to the advertising fee depending on clicks, and may be used to reduce uncertainty of the advertising fee that may occur according to flexibility of a number of clicks.

The number of clicks verification unit 703 may verify a number of clicks which may actually occur with respect to the advertisement during a time period corresponding to the period-based flat rate unit price. The number of clicks verification unit 703 may verify both the period-based flat rate unit price and the number of clicks which may actually occur with respect to the advertisement, and may calculate a specific fee per click depending on the clicks which may occur. For example, the number of clicks verification unit 703 may calculate the specific fee per click by multiplying the bid price per click and the number of the clicks.

The advertising fee calculation unit 704 may calculate an advertising fee depending on the exposure of the advertisement, based on the bid price per click, the period-based flat rate unit price, and the number of clicks. The advertising fee calculation unit 704 may calculate the advertising fee based on a specific fee per click determined based on the bid price per click and the number of clicks, a period-based flat rate fee determined based on the period-based flat rate unit price, and a weight for each fee determined through an administrator system in accordance with a request of the advertiser. That is, uncertainty that a number of clicks which may occur with respect to the advertisement during the time period may be unverifiable in advance may be reduced using a fixed fee, that is, the period-based flat rate unit price, and also an advertising fee depending on an advertising effect may be calculated based on the bid price per click.

The weight for each fee may include at least one of a ratio used to reflect the specific fee per click in the advertising fee, and a ratio used to reflect the period-based flat rate fee in the advertising fee. When the weight for each fee determined by the advertiser is used, portions of the fees corresponding to the period-based flat rate fee where an advertising fee may be verified in advance before exposing the advertisement, and the specific fee per click where the advertising fee may be calculated based on benefits of the advertisement may be adjusted to satisfy the request of the advertiser.

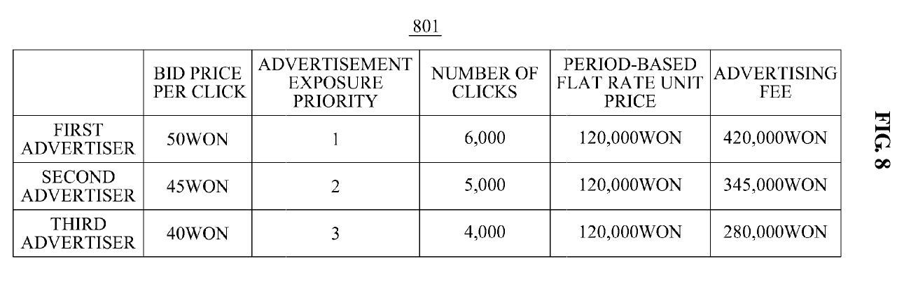

FIG. 8 is an example of a table 801 including information regarding a relationship among a bid price per click, a period-based flat rate unit price, a number of clicks, and an advertising fee. Each of a first advertiser through a third advertiser may input a bid price per click, and the auction system 101 may determine an advertisement exposure priority based on the bid price per click. The table 801 may represent that a higher advertisement exposure priority may be applied to an advertisement of an advertiser who may suggest a higher bid price per click, among the first advertiser through the third advertiser.

In this instance, advertisements of the advertisers may be exposed through corresponding advertisement exposure regions during a time period corresponding to a period-based flat rate unit price determined through an administrator system, using the advertising system 102. In this instance, the charging system 103 may determine advertising fees depending on the exposures of the advertisements based on the bid prices per click, the period-based flat rate unit prices, and the numbers of clicks. For example, the advertising fee of the first advertiser may be determined by multiplying the bid price per click and the number of clicks, and then by summing a result of the multiplication with the period-based flat rate unit price, that is, (“50 won”×“6,000”)+“120,000 won”=“420,000 won.”

Also, a weight for each fee corresponding to a predetermined ratio may be applied to the period-based flat rate fee of “120,000 won” determined based on the period-based flat rate unit price, or to a specific fee per click of “50 won×6,000” determined based on the bid price per click, and the number of clicks. For example, when a weight for each fee of “1.1” is applied to the specific fee per click, and a weight for each fee of “0.8” is applied to the period-based flat rate fee, for an advertiser who may desire to attach a higher importance to the specific fee per click, the advertising fee of the first advertiser may be calculated by (“50 won”×“6000”×“1.1”)+(“120,000 won”×“0.8”)=“426,000 won.” The weight for each fee may be predetermined by an administrator system in accordance with a request of the advertiser, before exposing the advertisement.

When using the auction system, the advertising system, and the charging system according to embodiments of the present invention, uncertainty of an advertising fee which may occur according to flexibility of a number of clicks may be reduced by determining an advertisement exposure priority through an auction using a bid price per click, and by calculating an advertising fee depending on an exposure of an advertisement through an advertisement exposure region corresponding to the advertisement exposure priority, based on all of the bid price per click, the period-based flat rate unit price determined through an administrator system, and the number of clicks which may actually occur during the time period corresponding to the period-based flat rate unit price. Also, various charging policies which may satisfy a request of an advertiser may be implemented by adjusting a ratio between the period-based flat rate fee determined based on the period-based flat rate unit price, and the specific fee per click determined based on the bid price per click and the number of clicks.

According to embodiments of the present invention, charging with respect to exposures of an advertisement may also be possible, in addition to charging with respect to clicks of an advertisement. The charging depending on the exposures may be performed through an equivalent configuration, using a bid price per exposure instead of the bid price per click, a number of exposures instead of the number of clicks, and a specific fee per exposure instead of the specific fee per click, and as such a duplicated to description will be omitted. In this case, uncertainty of an advertising fee according to flexibility of a number of exposures may be reduced.

The exemplary embodiments according to the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM discs and DVD; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be implemented to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. An advertising method comprising:
verifying an advertisement exposure priority determined with respect to an advertisement of an advertiser, based on a bid price per click (or a bid price per exposure) which is input from the advertiser; and
exposing the advertisement of the advertiser through an advertisement exposure region depending on the verified advertisement exposure priority, during a time period corresponding to a period-based flat rate unit price determined through an administrator system,
wherein an advertising fee depending on the exposure of the advertisement is calculated based on the bid price per click (or the bid price per exposure), a number of clicks (or a number of exposures) which actually occur with respect to the advertisement during the time period, and the period-based flat rate unit price.

2. The method of claim 1, wherein
the advertisement exposure priority corresponds to information regarding which advertisement exposure region an advertisement is exposed through, among a plurality of advertisement exposure regions included on a single webpage, and
when the bid price per click (or the bid price per exposure) is input to be higher, the advertisement is determined to be exposed through an uppermost position of the advertisement exposure region of the webpage.

3. The method of claim 1, wherein the advertising fee is calculated based on a specific fee per click (or a specific fee per exposure) determined based on the bid price per click (or the bid price per exposure) and based on the number of clicks (or the number of exposures), a period-based flat rate fee determined based on the period-based flat rate unit price, and a weight for each fee determined by the advertiser.

4. The method of claim 3, wherein the weight for each fee comprises at least one of a ratio used to reflect the specific fee per click (or the specific fee per exposure) in the advertising fee, and a ratio used to reflect the period-based flat rate fee in the advertising fee.

5. An auction method, comprising:
verifying a bid price per click (or a bid price per exposure) which is input from at least one advertiser; and
determining an advertisement exposure priority with respect to an advertisement of the advertiser based on the bid price per click (or the bid price per exposure),
wherein the advertisement is exposed through an advertisement exposure region depending on the advertisement exposure priority, and
an advertising fee depending on the exposure of the advertisement is calculated based on the bid price per click (or the bid price per exposure), a period-based flat rate unit price determined through an administrator system, and a number of clicks (or a number of exposures) which actually occur with respect to the advertisement during a time period corresponding to the period-based flat rate unit price.

6. The method of claim 5, wherein the advertisement is exposed through the advertisement exposure region during the time period corresponding to the period-based flat rate unit price.

7. The method of claim 5, wherein the advertising fee is calculated based on a specific fee per click (or a specific fee per exposure) determined based on the bid price per click (or the bid price per exposure) and based on the number of clicks (or the number of exposures), a period-based flat rate fee determined based on the period-based flat rate unit price, and a weight for each fee determined by the advertiser.

8. The method of claim 7, wherein the weight for each fee comprises at least one of a ratio used to reflect the specific fee per click (or the specific fee per exposure) in the advertising fee, and a ratio used to reflect the period-based flat rate fee in the advertising fee.

9. A charging method, comprising:
verifying a bid price per click (or a bid price per exposure) of an advertisement exposed through an advertisement exposure region;
verifying a period-based flat rate unit price determined through an administrator system;
verifying a number of clicks (or a number of exposures) which actually occur with respect to the advertisement during a time period corresponding to the period-based flat rate unit price; and
calculating an advertising fee depending on the exposure of the advertisement, based on the bid price per click (or the bid price per exposure), the number of clicks (or the number of exposures), and the period-based flat rate unit price.

10. The method of claim 9, wherein the advertisement is exposed through an advertisement exposure region corresponding to an advertisement exposure priority determined based on the bid price per click (or the bid price per exposure), among a plurality of advertisement exposure regions.

11. The method of claim 9, wherein the calculating comprises calculating the advertising fee based on a specific fee per click (or a specific fee per exposure) determined based on the bid price per click (or the bid price per exposure) and based on the number of clicks (or the number of exposures), a period-based flat rate fee determined based on the period-based flat rate unit price, and a weight for each fee determined by the advertiser.

12. The method of claim 11, wherein the weight for each fee comprises at least one of a ratio used to reflect the specific fee per click (or the specific fee per exposure) in the advertising fee, and a ratio used to reflect the period-based flat rate fee in the advertising fee.

13. A non-transitory computer-readable medium comprising a program for instructing a computer to perform the method of any one of claim 1 to claim 12.

14. An advertising system, comprising:
an advertisement exposure priority verification unit to verify an advertisement exposure priority determined with respect to an advertisement of an advertiser, based on a bid price per click (or a bid price per exposure) which is input from the advertiser; and
an advertisement exposure unit to expose the advertisement of the advertiser through an advertisement exposure region depending on the verified advertisement exposure priority, during a time period corresponding to a period-based flat rate unit price determined through an administrator system,
wherein an advertising fee depending on the exposure of the advertisement is calculated based on the bid price per click (or the bid price per exposure), a number of clicks (or a number of exposures) which actually occur with respect to the advertisement during the time period, and the period-based flat rate unit price.

15. The system of claim 14, wherein
the advertisement exposure priority corresponds to information regarding which advertisement exposure region an advertisement is exposed through, among a plurality of advertisement exposure regions included on a single webpage, and
when the bid price per click (or the bid price per exposure) is input to be higher, the advertisement is determined to be exposed through an uppermost position of the advertisement exposure region of the webpage.

16. The system of claim 14, wherein the advertising fee is calculated based on a specific fee per click determined based on the bid price per click (or the bid price per exposure) and based on the number of clicks (or the number of exposures), a period-based flat rate fee determined based on the period-based flat rate unit price, and a weight for each fee determined by the advertiser.

17. An auction system, comprising:
a bid price per click (bid price per exposure) verification unit to verify a bid price per click (or a bid price per exposure) which is input from at least one advertiser; and
an advertisement exposure priority determination unit to determine an advertisement exposure priority with respect to an advertisement of the advertiser based on the bid price per click (or the bid price per exposure),
wherein the advertisement is exposed through an advertisement exposure region depending on the advertisement exposure priority, and
an advertising fee depending on the exposure of the advertisement is calculated based on the bid price per click (or the bid price per exposure), a period-based flat rate unit price determined through an administrator system, and a number of clicks (or a number of exposures) which actually occur with respect to the advertisement during a time period corresponding to the period-based flat rate unit price.

18. The system of claim 17, wherein the advertisement is exposed through the advertisement exposure region during the time period corresponding to the period-based flat rate unit price.

19. The system of claim 17, wherein the advertising fee is calculated based on a specific fee per click (or a specific fee per exposure) determined based on the bid price per click (or the bid price per exposure) and based on the number of clicks (or the number of exposures), a period-based flat rate fee determined based on the period-based flat rate unit price, and a weight for each fee determined by the advertiser.

20. A charging system, comprising:
a bid price per click (bid price per exposure) verification unit to verify a bid price per click (or a bid price per exposure) of an advertisement exposed through an advertisement exposure region;
a bid price per click verification unit to verify a period-based flat rate unit price determined through an administrator system;
a number of clicks (number of exposures) verification unit to verify a number of clicks (or a number of exposures) which actually occur with respect to the advertisement during a time period corresponding to the period-based flat rate unit price; and
an advertising fee calculation unit to calculate an advertising fee depending on the exposure of the advertisement, based on the bid price per click (or the bid price per exposure), the number of clicks (or the number of exposures), and the period-based flat rate unit price.

21. The system of claim 20, wherein the advertisement is exposed through an advertisement exposure region corresponding to an advertisement exposure priority determined based on the bid price per click (or the bid price per exposure), among a plurality of advertisement exposure regions.

22. The system of claim 20, wherein the advertising fee calculation unit calculates the advertising fee based on a specific fee per click (or a specific fee per exposure) determined based on the bid price per click (or the bid price per exposure) and based on the number of clicks (or the number of exposures), a period-based flat rate fee determined based on the period-based flat rate unit price, and a weight for each fee determined by the advertiser.
